(19) United States
(12) Patent Application Publication
(10) Pub. No.: US 2024/0103247 A1
(43) Pub. Date: Mar. 28, 2024

(54) LENS ASSEMBLY AND LENS MODULE INCLUDING THE SAME

(71) Applicant: SAMSUNG ELECTRO-MECHANICS CO., LTD., Suwon-si (KR)

(72) Inventors: Seong Jin CHOI, Suwon-si (KR); Young Suk KANG, Suwon-si (KR); Yong Joo JO, Suwon-si (KR)

(73) Assignee: SAMSUNG ELECTRO-MECHANICS CO., LTD., Suwon-si (KR)

(21) Appl. No.: 18/355,819

(22) Filed: Jul. 20, 2023

(30) Foreign Application Priority Data
Sep. 22, 2022 (KR) 10-2022-0119741
Apr. 10, 2023 (KR) 10-2023-0047063

(51) Int. Cl. G02B 7/02

(52) U.S. Cl. CPC G02B 7/021; G02B 7/026

(57) ABSTRACT

A lens assembly includes a lens barrel, a plurality of lenses arranged inside the lens barrel along an optical axis, and a cover member fixed to an end of the lens barrel on a subject side and fixing a last lens of the plurality of lenses on the subject side, wherein outer diameters of the plurality of lenses decrease from the subject side to an image side, and an outer diameter of the lens barrel is constant or smaller from the subject side to the image side.

### CROSS-REFERENCE TO RELATED APPLICATIONS

This application claims the benefit under 35 USC 119(a) of Korean Patent Application Nos. 10-2022-0119741 filed on Sep. 22, 2022, and 10-2023-0047063 filed on Apr. 10, 2023, in the Korean Intellectual Property Office, the entire disclosures of which are incorporated herein by reference for all purposes.

### BACKGROUND

### 1. Field

The present disclosure relates to a lens assembly and a lens module including the same.

### 2. Description of the Background

Camera modules may be employed in portable electronic devices such as smartphones.

A camera module may be provided with a lens assembly including a plurality of lenses. The number of lenses may be increased to improve the performance of the camera module, and the size of the camera module may be miniaturized.

Moreover, a lens holder may be provided in the lens assembly with the lenses. The lens holder may include an actuator for correcting a shake (optical image stabilization (OIS) actuator) and an autofocus (AF) actuator (AF actuator), which may be assembled to the housing of the lens module.

That is, because the camera module may have a shake correction function and an autofocus control function in the lens holder in order to maximize its performance, a number of parts may be already provided, thereby having a volume greater than without such functions and components.

Accordingly, there may be a limit in reducing the size of the lens module, which may be desired to be miniaturized, by reducing the lens holder size or parts provided thereto.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens assembly includes a lens barrel, a plurality of lenses arranged inside the lens barrel along an optical axis, and a cover member fixed to an end of the lens barrel on a subject side and fixing a last lens of the plurality of lenses on the subject side, wherein outer diameters of the plurality of lenses decrease from the subject side to an image side, and wherein an outer diameter of the lens barrel is constant or smaller from the subject side to the image side.

An inner diameter of the lens barrel may decrease from the subject side to the image side corresponding to the outer diameters of the plurality of lenses.

The cover member may have an outer diameter larger than that of the lens barrel.

The cover member may have a contact portion contacting an outer diameter portion of the last lens on the subject side of the lens barrel.

The cover member may include a fixing portion into which the outer diameter of the lens barrel is fitted.

The fixing portion may be a screw-assembled to the outer diameter of the lens barrel.

The fixing portion may be slide-fitted to the outer diameter of the lens barrel.

The fixing portion may be press-fitted to the lens barrel.

The fixing portion may be fixed to the lens barrel by bonding using an adhesive.

A coating surface may be provided for preventing flare on an outer surface of the contact portion.

The plurality of lenses may implement an ultra-wide-angle lens.

An angle of view of the ultra-wide-angle lens may me 120 to 130 degrees.

A lens module may include the lens assembly, wherein the image side of the lens barrel may be accommodated in a housing.

In another general aspect, a lens module includes a lens barrel including a plurality of lenses disposed therein along an optical axis, a circular cover member fixed to an end of the lens barrel on a subject side and fixing a last lens of the plurality of lenses on the subject side, and a rectangular housing for accommodating the lens barrel therein, wherein outer diameters of the plurality of lenses decrease from the subject side to an image side, and a ratio of a diameter of the cover member to a length of a longest side of the housing is in a range of 7:10 to 9:10.

An outer diameter of the lens barrel may decrease stepwise from the subject side to the image side.

An outer diameter of the lens barrel may be parallel to a direction of the optical axis.

In another general aspect, a lens assembly includes a lens barrel having an outer diameter at an image side equal to or less than an outer diameter at a subject side, and a wall having a thickness at the image side equal to or greater than a thickness at the subject side, a plurality of lenses disposed in the lens barrel, and a cover member fixed to an end of the lens barrel on the subject side and fixing a last lens of the plurality of lenses on the subject side.

Outer diameters of the plurality of lenses may decrease from the subject side to the image side, and an inner diameter of the lens barrel may decrease corresponding to the outer diameters of the plurality of lenses.

The image side of the lens barrel may be accommodated in a rectangular housing and a ratio of a diameter of the cover member to a length of a longest side of the housing may be in a range of 7:10 to 9:10.

Other features and aspects will be apparent from the following detailed description, the drawings, and the claims.

### BRIEF DESCRIPTION OF DRAWINGS

FIG. 1 is a schematic perspective view of a lens assembly according to an embodiment of the present disclosure.

FIG. 2 is a schematic front view of a lens assembly according to an embodiment of the present disclosure.

FIG. 3 is a schematic cross-sectional view of a lens assembly according to an embodiment of the present disclosure.

FIG. 4 is a schematic exploded perspective view of a lens assembly according to an embodiment of the present disclosure.

FIG. 5 is a perspective view of a lens assembly according to another embodiment of the present disclosure.

FIG. 6 is a perspective view of a lens module according to an embodiment of the present disclosure.

FIG. 7 is a reference diagram for illustrating a length ratio of parts included in a lens module according to an embodiment of the present disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An object according to one or more embodiments of the present disclosure is to reduce the size of an entire lens module by utilizing volume reduction of a lens assembly.

An object according to one or more embodiments of the present disclosure is to provide a compact lens module while maintaining maximum performance of a lens assembly.

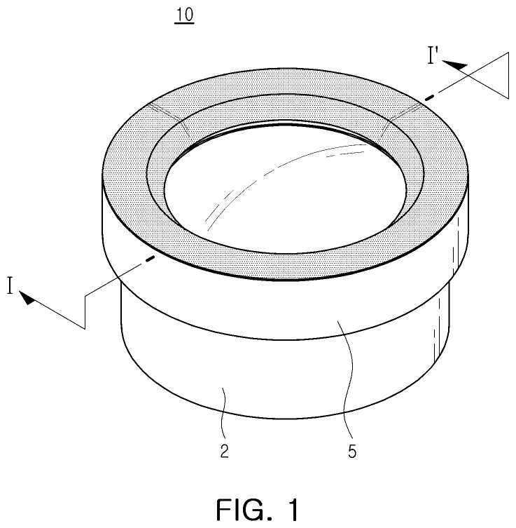

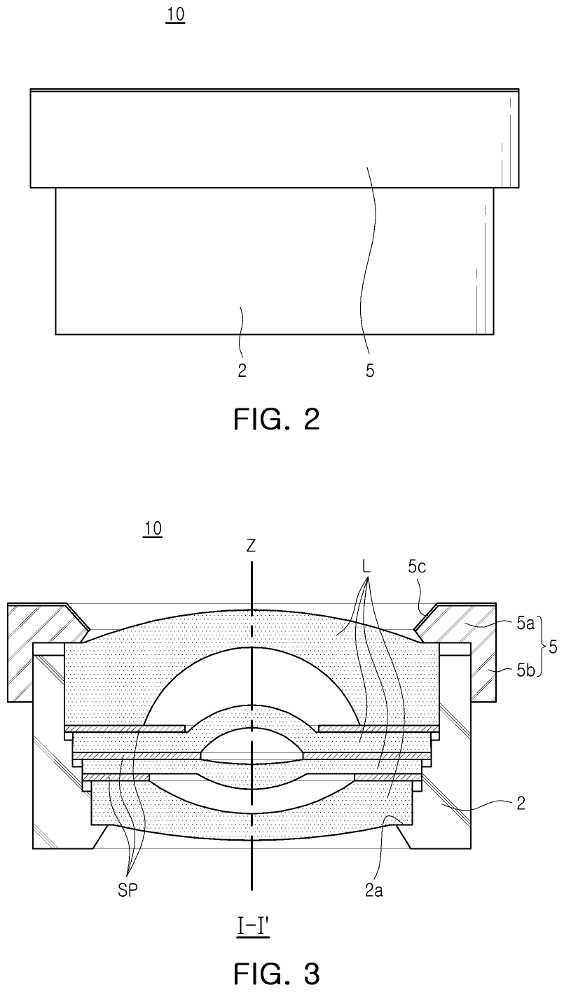

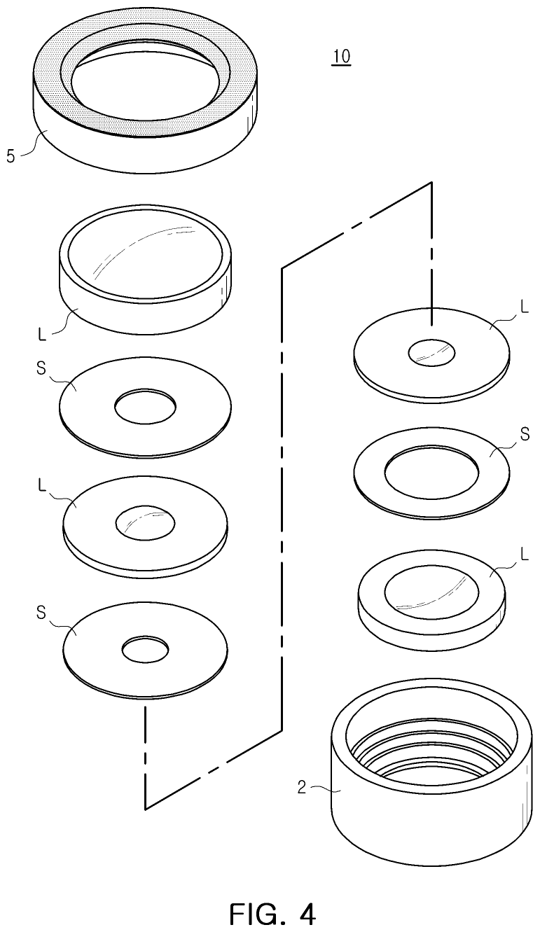

FIG. 1 is a schematic perspective view of a lens assembly according to an example embodiment in the present disclosure; FIG. 2 is a schematic front view of a lens assembly according to an embodiment of the present disclosure; FIG. 3 is a schematic cross-sectional view of a lens assembly according to an embodiment of the present disclosure; and FIG. 4 is a schematic exploded perspective view of a lens assembly according to an embodiment of the present disclosure.

Referring to FIGS. 1 to 4, a lens assembly 10 according to an example embodiment in the present disclosure includes a lens barrel 2 and a plurality of lenses L arranged inside the lens barrel 2. The lens barrel 2 may be provided with a cover member 5 at an end of a subject side.

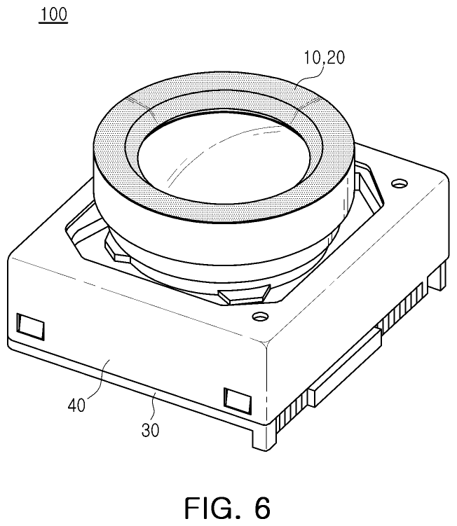

The lens barrel 2 may be assembled to the housing 30 of the lens module 100 (see FIG. 6). The cover member 5 may be provided closer to the subject side than a lens holder, and may include a contact portion 5a for contacting the outermost lens closest to the subject side and a fixing portion 5b for fitting the outer diameter of the lens barrel 2.

The lens barrel 2 has a hollow inner portion, and the hollow inner portion may be provided to be stepped so that the inner diameter thereof decreases from the subject side, i.e., an upper side in FIG. 3 to an image side, i.e., a lower side in FIG. 3. The lens barrel 2 may be provided with a support portion 2a protruding into the hollow inner portion at an end of the image side. Also, the outer diameter of the lens barrel 2 may be parallel to an optical axis. That is, the outer diameter of the lens barrel 2 may be uniformly provided as a whole.

The plurality of lenses L are fitted into the stepped inner diameter of the lens barrel 2. Accordingly, the inner diameter of the lens barrel 2 may be provided to correspond to the outer diameters of the plurality of lenses L.

The lens assembly 10 may include at least two, that is, a plurality of, lenses L disposed inside the lens barrel 2 along the optical axis Z, and a spacer SP provided between the at least two lenses L. For example, one or more spacers SP may be included where a spacer SP of the one or more spacers SP may be disposed between each adjacent ones of the at least two lenses L as illustrated in FIG. 3. The lens assembly 10 of the present embodiment may be used for both a wide-angle lens assembly and a telephoto lens assembly, and, for example, may be used for a wide-angle lens assembly or an ultra-wide-angle lens assembly. In the case of an ultra-wide-angle lens, the angle of view may be 120 to 130 degrees.

In the present embodiment, a structure including four lenses is presented as an example, and this is only an example, and the lens assembly including at least two lenses is included in all embodiments of the present disclosure.

And, as shown in FIG. 3, the lenses L may include an optical portion that expresses an optical effect and a rib surrounding the rim of the optical portion. The optical portion may exert an optical effect by itself or in combination with a plurality of lenses. The rib is not intended for an optical effect and may be used to support or align the lenses.

Here, when expressed as the diameter or outer diameter of the lenses (L) without separate explanation, it corresponds to the entire structure including both the optical portion and the rib.

The optical portion and the rib may be provided in a disk shape, and thus, the optical portion may have a circular shape having a predetermined radius around the central optical axis Z, and the rib may be provided in a ring shape on the outer side thereof. And, for convenience of description, a circumferential direction is defined as an edge direction of a circle having a predetermined radius around the optical axis Z.

Accordingly, the lens barrel 2 accommodating the lenses L therein may also have a substantially cylindrical shape, and the cover member 5 covering the lens barrel 2 from the subject side may also have a substantially cylindrical shape.

One or more lens of the lenses L may have a D-cut portion (notch) in which a portion of the rib is cut, and the D-cut portion may have a straight shape. In an example, a portion of the rib and a portion of the optical portion may be cut in the D-cut portion, and the D-cut portion may have a straight shape.

The lens assembly 10 may be assembled by sequentially stacking the plurality of lenses L and spacers SP on the lens barrel 2.

The lens barrel 2 includes a portion with a narrower inner diameter, i.e., a lower portion in FIG. 3, and an upper portion with a relatively large inner diameter and an opening, and the lenses L may be sequentially fitted through the opening of the upper portion. After the last lens on the subject side is fitted, the cover member 5 may be fitted onto the lens barrel 2. In this way, the lens barrel 2 may be assembled.

In FIG. 3, the upper side corresponds to the subject side, and the lower side corresponds to the image side. Therefore, in the present embodiment, the lens on the image side may be first fitted into the lens barrel 2, and the lens on the subject side may be assembled later.

In addition, in the present embodiment, the diameter of the lenses decreases from the subject side to the image side. Accordingly, the lens barrel 2 goes through the process of first assembling the lens with a small diameter which is closer to the image side, and sequentially assembling the lens of the subject side.

That is, in the plurality of lenses, the outer diameter of the lens provided on the subject side may be larger than that on the image side. In addition, the inner diameter of the lens barrel 2 is also provided with a larger diameter on the subject side accordingly.

In addition, since the plurality of lenses L are mutually combined to express an optical effect, when sequentially assembling the lenses L in the lens barrel 2, the lenses L are assembled by finding the optimal position thereof while rotating them in the circumferential direction, respectively.

For example, when assembling the lenses L, it is possible to optimize the direction with regard to a mechanical error (concentricity/eccentricity) by rotating them in a direction most consistent with the optical axis. Optimized assembly is possible by assembling each lens L at an optimized angle by rotating it by 90 degrees in the circumferential direction based on the D-cut portion formed at one end of the circular lens.

In an example, the lenses L and the spacers SP are assembled to the lens barrel 2, and the cover member 5 is assembled to the end of the subject side. The cover member 5 is fixed to the end of the lens barrel on the subject side, and fixes the last lens on the subject side.

The cover member 5 may have a substantially cylindrical shape, and may include a contact portion 5a contacting the outer diameter portion of the last lens of the lens barrel 2 on the subject side and a fixing portion 5b into which the outer diameter of the lens barrel 2 is fitted.

The fixing portion 5b may be screw-assembled (i.e., screwed, for this purpose, a female thread or a male thread being selectively provided on the inner diameter of the fixing portion 5b and the outer diameter of the lens barrel 2), slide-fitted, or press-fitted to the outer diameter of the lens barrel 2.

In addition, the fixing portion 5b may be fixed to the lens barrel 2 by bonding using an additional adhesive. The adhesive may be applied between the inner diameter of the fixing portion 5b and the outer diameter of the lens barrel 2, or may be applied to the end of the fixing portion 5b, that is, to the lowermost part of the image side of the fixing portion 5b.

The outer diameter of the cover member 5 may be larger than that of the lens barrel 2. That is, the outer diameter of the fixing portion 5b of the cover member 5 may be larger than any part of the outer diameter of the lens barrel 2.

A coating surface 5c may be provided for preventing flare on the outer surface of the cover member 5.

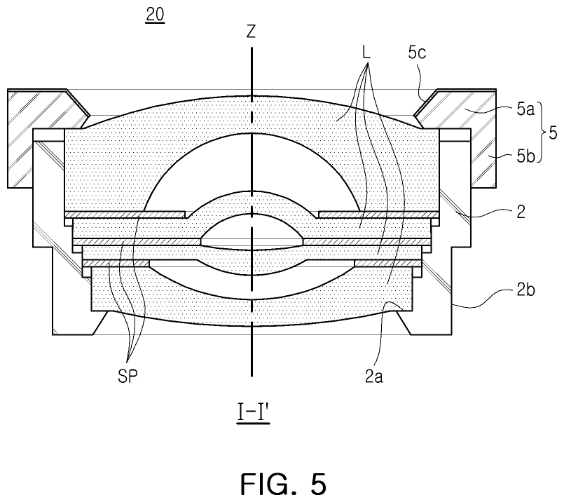

FIG. 5 is a perspective view of a lens assembly according to another embodiment of the present disclosure.

Referring to FIG. 5, a lens assembly 20 according to another embodiment may include a stepped portion 2b on an outer surface of the lens barrel 2. That is, the lens barrel 2 may include the stepped portion 2b so that the outer diameter thereof is reduced toward the image side more than the subject side. Since other configurations (structures) other than the stepped portion 2b are the same as those of the lens assembly 10 of an embodiment described with reference to FIGS. 1 to 4, the detailed structural descriptions are replaced with those described above.

In the lens assembly 20 according to another embodiment, since the outer diameter of the image-side portion where the lens assembly 20 is coupled to the lens holder is smaller, the size of the lens holder can be further miniaturized, and accordingly, the overall size of the lens module can be further miniaturized.

FIG. 6 is a perspective view of a lens module according to an embodiment of the present disclosure.

Referring to FIG. 6, the lens module 100 according to an embodiment of the present disclosure includes a lens assembly 10 and 20 of an embodiment or another embodiment provided in a housing 30. Further, the housing 30 may be provided with a cover member 40 covering the housing 30 so that upper portion of the lens assembly 10 and 20 is exposed. In addition, since the lens assembly 10 and 20 provided in the housing have been described in detail with reference to FIGS. 1 to 5, the structural descriptions thereof are replaced with those described above.

Since the lens module 100 of the present embodiment accommodates the lens assembly 10 and 20 in which the outer diameter of the lens barrel 2 on the image side may be further reduced, the size of the accommodating portion can be reduced. Accordingly, the overall size of the lens module 100 may be reduced.

The lens module 100 of the present embodiment may include a lens barrel 2 having a plurality of lenses arranged therein along an optical axis, a circular cover member 5 fixed to an end of the lens barrel on a subject side and fixing the last lens on the subject side, and a rectangular housing 30 for accommodating the lens barrel 2 therein.

Further, the outer diameter of the plurality of lenses may decrease from the subject side to an image side, and correspondingly, the inner diameter of the lens barrel 2 may also be provided to be smaller stepwise.

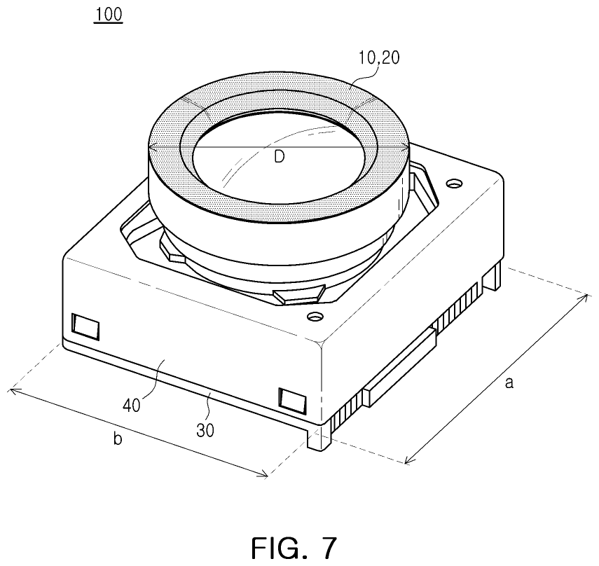

Referring to FIG. 7, the ratio of the diameter D of the cylindrical cover member 5 and the length of the longest side of the rectangular housing 30 (a, a>b, or a=b) may be provided in the range of 3:10 to 9:10. For example, the ratio of the diameter D of the cover member 5 and the length of the longest side of the rectangular housing 30 (a, a>b, or a=b) may be provided in the range of 7:10 to 9:10. The size of the lenses may not exceed the size of the housing, and may be set to a maximum of 90% in consideration of the assembly property of the cover member 40 of the housing 30. However, it is not limited thereto, and with the development of manufacturing technology, the ratio may be improved up to 99%, so that the ratio of the diameter D of the cover member 5 and the length of the longest side of the rectangular housing 30 (a, a>b, or a=b) may approach 9.9:10.

That is, a relatively large cover member 5 may be provided compared to the housing 30, and accordingly, the size of the housing 30 may be relatively reduced, which may achieve the miniaturization of the entire size of the lens module 100.

A lens assembly according to one or more embodiments of the present disclosure may provide a lens assembly capable of reducing the size of an entire lens module when coupled to the lens module while maintaining or improving performance thereof.

The size of the lens module according to one or more embodiments of the present disclosure may be reduced while maintaining or improving performance thereof.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens assembly comprising:
a lens barrel;
a plurality of lenses arranged inside the lens barrel along an optical axis; and
a cover member fixed to an end of the lens barrel on a subject side and fixing a last lens of the plurality of lenses on the subject side,
wherein outer diameters of the plurality of lenses decrease from the subject side to an image side, and
wherein an outer diameter of the lens barrel is constant or smaller from the subject side to the image side.

2. The lens assembly of claim 1, wherein an inner diameter of the lens barrel decreases from the subject side to the image side corresponding to the outer diameters of the plurality of lenses.

3. The lens assembly of claim 1, wherein the cover member has an outer diameter larger than that of the lens barrel.

4. The lens assembly of claim 1, wherein the cover member has a contact portion contacting an outer diameter portion of the last lens on the subject side of the lens barrel.

5. The lens assembly of claim 1, wherein the cover member includes a fixing portion into which the outer diameter of the lens barrel is fitted.

6. The lens assembly of claim 5, wherein the fixing portion is screw-assembled to the outer diameter of the lens barrel.

7. The lens assembly of claim 5, wherein the fixing portion is slide-fitted to the outer diameter of the lens barrel.

8. The lens assembly of claim 5, wherein the fixing portion is press-fitted to the lens barrel.

9. The lens assembly of claim 5, wherein the fixing portion is fixed to the lens barrel by bonding using an adhesive.

10. The lens assembly of claim 4, wherein a coating surface is provided for preventing flare on an outer surface of the contact portion.

11. The lens assembly of claim 1, wherein the plurality of lenses implement an ultra-wide-angle lens.

12. The lens assembly of claim 11, wherein an angle of view of the ultra-wide-angle lens is 120 to 130 degrees.

13. A lens module comprising the lens assembly of claim 1, wherein the image side of the lens barrel is accommodated in a housing.

14. A lens module comprising:
a lens barrel including a plurality of lenses disposed therein along an optical axis;
a circular cover member fixed to an end of the lens barrel on a subject side and fixing a last lens of the plurality of lenses on the subject side; and
a rectangular housing for accommodating the lens barrel therein,
wherein outer diameters of the plurality of lenses decrease from the subject side to an image side, and
wherein a ratio of a diameter of the cover member to a length of a longest side of the housing is in a range of 7:10 to 9:10.

15. The lens module of claim 14, wherein an outer diameter of the lens barrel decreases stepwise from the subject side to the image side.

16. The lens module of claim 14, wherein an outer diameter of the lens barrel is parallel to a direction of the optical axis.

17. A lens assembly comprising:
a lens barrel comprising an outer diameter at an image side equal to or less than an outer diameter at a subject side, and a wall having a thickness at the image side equal to or greater than a thickness at the subject side;
a plurality of lenses disposed in the lens barrel; and
a cover member fixed to an end of the lens barrel on the subject side and fixing a last lens of the plurality of lenses on the subject side.

18. The lens assembly of claim 17, wherein outer diameters of the plurality of lenses decrease from the subject side to the image side, and an inner diameter of the lens barrel decreases corresponding to the outer diameters of the plurality of lenses.

19. A lens module comprising the lens assembly of claim 17, wherein the image side of the lens barrel is accommodated in a rectangular housing and a ratio of a diameter of the cover member to a length of a longest side of the housing is in a range of 7:10 to 9:10.
